(19) United States
(12) Patent Application Publication
(10) Pub. No.: US 2012/0284769 A1
(43) Pub. Date: Nov. 8, 2012

(54) Systems and Methods of Intelligent Policy-Based Geo-Fencing

(76) Inventors: Kyle Dixon, Plano, TX (US); Fernando Vazquez, Frisco, TX (US)

(21) Appl. No.: 13/102,715

(22) Filed: May 6, 2011

(51) Int. Cl. H04L 29/06

(52) U.S. Cl. 726/1

(57) ABSTRACT

Systems and methods of intelligent policy-based geo-fencing provide the ability to associate a context to a geo-fence using conditions/rules/criteria and attributes retrieved in real-time to offer greater intelligence in determining if an action should be performed. Using policies and attributes uniquely associated with a geo-fence, geo-fence concepts may be enhanced to provide granular and flexible decision-making with regard to spatial awareness. The result of these dynamic decisions may then be mapped to any number of actions to produce alerts, notifications or messages.

### FIELD OF THE INVENTION

The disclosure relates generally to geo-fencing, and more specifically, to intelligent policy-based geo-fencing.

### BACKGROUND

Geo-fencing, or using a geo-fence, generally involves providing an alert or notification when a person or object, enters and/or exits a predefined virtual perimeter or boundary threshold. Geo-fencing has been used in connection with location-based service applications or social networking applications to transmit content, such as coupons or “check-in” status, to users of the respective applications. However, these types of geo-fences simply verify the coordinates of an individual or object fall inside or outside of the geo-fence, and, if so, an alert or notification may be disseminated.

### SUMMARY

Embodiments of the present disclosure generally provide a method of policy-based geo-fencing using a server-based geo-fencing system. The server-based geo-fencing system may comprise at least one server and at least one storage device and at least one communication network. The at least one server may receive signals from at least one event device through the at least one communication network. The at least one server may transmit signals to at least one event device through said at least one communication network.

The method according to embodiments of the present disclosure may comprise receiving an event. An event may comprise an asset-driven event, an attribute-driven event, and/or an anchor-driven event. Further, an attribute-driven event may include a change in at least one attribute selected from the group comprising: time of day, hours worked, weather, DEFCON, and Air Quality Index. A geo-fence associated with a server-based system may be fixed or mobile. Upon receipt of an event, all qualified geo-fences may be evaluated.

Such a method of policy-based geo-fencing according to embodiments of the present disclosure may further include evaluating at least one geo-fencing policy to produce a first result. The first result may be “in,” “out,” or “indeterminate.” The first result may then be mapped to at least one geo-fencing condition policy. The at least one geo-fencing condition policy may fetch real-time attribute values to be used in an evaluation of the at least one geo-fencing condition policy to produce a second result. Real-time attribute values may be selected from the group comprising device attributes, asset attributes, landmark attributes, environment attributes, and geo-fence attributes. The second result may be “true,” “false,” or “indeterminate.”

The second result may then be mapped to at least one geo-fencing condition result action. The at least one geo-fencing condition result action may then be invoked. The at least one geo-fencing condition result action may be selected from the group comprising sending an alert, message or notification, modifying a geo-fence, modifying a geo-fencing policy, sending another event to the geo-fencing system, and updating or modifying attributes in at least one storage device.

Embodiments of the present disclosure may further provide a method of geo-fencing using a server-based geo-fencing system. The server-based geo-fencing system may comprise at least one server and at least one storage device and at least one communication network. The at least one server may receive signals from at least one event device through the at least one communication network. Such a method may comprise invoking at least one geo-fencing condition result action by evaluating at least one geo-fencing policy and at least one geo-fencing condition policy. The method may also comprise mapping the result of evaluating the at least one geo-fencing policy to the at least one geo-fencing condition policy. The method may further comprise mapping the result of evaluating the at least one geo-fencing condition policy to the at least one geo-fencing condition result action. At least one geo-fencing condition result action may be selected from the group comprising sending an alert, message or notification, modifying a geo-fence, modifying a geo-fencing policy, sending an event, and updating or modifying attributes in at least one storage device.

Embodiments of the present disclosure may provide a method for dynamically connecting assets to one another with a server-based geo-fencing system by configuring a geo-fencing policy to require each asset within a group to remain within a predefined distance of the other assets within said group, evaluating the geo-fencing policy and mapping the geo-fencing policy to at least one geo-fencing condition policy, evaluating and mapping the at least one geo-fencing condition policy to at least one geo-fencing condition result action, and invoking at least one geo-fence condition result action. Each asset within the group may be individually identified and evaluated by the server-based geo-fencing system. The assets also may define the group based on the condition that the assets abide by the geo-fencing condition policy.

### BRIEF DESCRIPTION OF THE DRAWINGS

For a more complete understanding of this disclosure and its features, reference is now made to the following description, taking in conjunction with the following drawings, in which:

FIG. 1 depicts a flow chart of a method of intelligent policy-based geo-fencing according to an embodiment of the present disclosure;

FIG. 2 depicts a geo-fencing system according to embodiments of the present disclosure;

FIG. 3 depicts a flow chart of intelligent policy-based geo-fencing for an “all” type scenario according to an embodiment of the present disclosure; and

FIG. 4 depicts a flow chart of intelligent policy-based geo-fencing without an “all” type scenario according to an embodiment of the present disclosure.

### DETAILED DESCRIPTION

Embodiments of the present disclosure provide a geo-fence that may be associated with a user or group of users. Such a geo-fence may move along with the user or group of users and respond to events or parameters. When referring to a geo-fence or geo-fencing in connection with embodiments of the present disclosure, it should be appreciated that a geo-fence is generally considered to be a virtual perimeter around a geographic area that may include attributes, such as qualities or characteristics, that may assist in defining the area.

Geo-fences according to embodiments of the present disclosure may maintain a unique configurable policy that may analyze data and attributes. A policy may be an expression or structure of logic and rules using attributes or other criteria to define a procedure, protocol and/or set of conditions. The data and attributes may work in conjunction with a threshold event (or lack thereof) to stipulate if, when, and how an action may be performed. Actions that may be performed according to embodiments of the present disclosure may include, but are not necessarily limited to, sending alerts, messages, and/or notifications, modifying a policy, and/or modifying a geo-fence perimeter or territory of coverage. While these actions have been identified, it should be appreciated that other actions not specifically listed may be performed without departing from the present disclosure. This policy and action processing may be referred to as “intelligent policy-based geo-fencing,” although other terms or phases may be used to refer to this type of geo-fence processing without departing from the present disclosure.

Intelligent policy-based geo-fencing may provide a context to a given territory using conditions, rules, and/or criteria and attributes received in real-time. Those conditions, rules and/or criteria may then be evaluated to determine if a certain action should be performed. This evaluation provides for enhanced result-action processing, such as alerting or notification, and flexible decision-making related to geo-fences.

In order to understand how intelligent policy-based geo-fencing may differ from more traditional geo-fencing, it may be helpful to provide a few examples for comparison. In a more traditional geo-fencing model, a text message may be sent to a child's parent to notify the parent if his/her child exits a particular geo-fence, such as the geo-fence associated with the child's neighborhood. In contrast, using intelligent policy-based geo-fencing according to embodiments of the present disclosure, a text message may be sent to a child's parent when the child exits a particular geo-fence, such as the geo-fence of his/her neighborhood, and such exit occurs within a specified time frame (such as between 5 pm and 7 pm or after the child's curfew). Geo-fencing according to these embodiments may permit a parent to keep track of or monitor his/her child, particularly if the child is supposed to remain in a certain area after he/she leaves school at the end of the day.

In another embodiment of the present disclosure, intelligent policy-based geo-fencing may provide that a text message or other notification be sent to the parent of any child under a certain age (i.e., the age of 10 years old) that exits a particular geo-fence, such as a geo-fence associated with an after-school day care facility. Accordingly, such a geo-fence may not be limited to a specific child but rather may encompass all children falling within a certain class (i.e., under the age of 10 years old).

In a further embodiment of the present disclosure, additional or different parameters may be identified to control and monitor operation of a geo-fence. For example, an alert or notification may be sent to a child's parent if certain weather or environmental conditions are present (i.e., it is raining) and the child exits a particular geo-fence. As an example, if the child is not supposed to leave his/her house when it is raining or there is lightning in the area, the child's parent may be notified if the child leaves the house under those conditions.

In another embodiment of the present disclosure, an alert or notification may be sent if a child exits a specified geo-fence on certain day(s) of the week. For instance, if the child is supposed to stay home to do homework and not visit a friend's house on school nights, the child's parent may be notified if the child goes to the friend's house on such a school night.

Age of the child, weather conditions, and/or day(s) of the week, among other conditions, may be attributes applied to a geo-fence according to embodiments of the present disclosure. The respective values of these attributes may be retrieved and then evaluated to determine if an alert or notification may need to be sent. Such an evaluation of the attribute values also may assist a user to determine if another policy or geo-fence condition may need to be modified.

With intelligent policy-based geo-fencing according to embodiments of the present disclosure, an alert or notification may be issued if no one has entered a geo-fence associated with a given territory over a specified time frame. Such an alert or notification may prompt the recipient (such as a security officer tasked to monitor a specific property or territory) to increase the size of the territory or area contained within the geo-fence by a specified amount (such as increasing the size by a 1-mile radius).

Additionally or alternatively, an alert or notification may be issued to reduce the size of the geo-fence associated with a given territory if more than a specified number of people enter over a specified time frame. For example, a security officer may be tasked to a monitor an area, such as a section of a stadium during a sporting event, to address crowd control issues. If more than a specified number of spectators enter the area within a certain period of time, an alert may be issued to narrow the size of the geo-fence so that the security officer is not overwhelmed by the number of spectators to be monitored. Additionally or alternatively, an alert or notification may be issued to adjust the number of security officers in the area covered by that particular geo-fence. Accordingly, in these embodiments, a policy result may serve to modify the geo-fence as the result action may be performed.

In a further embodiment of the present disclosure, an alert or notification may be made if no one having a specified title or position (such as “supervisor” or “security officer”) has entered a specified geo-fence over a certain time frame. As an example, a facility may desire to have its security officer patrol a given area of a facility each hour. If the security officer does not pass through that area each hour, an alert or notification may be sent to the head of security. In this embodiment, title and time of day may be attributes applied to the geo-fence. The respective values for these attributes may be retrieved and evaluated to determine if an alert or notification may need to be sent. Such an evaluation also may assist the user in determining if other policy or geo-fence conditions may need to be modified in response to the attribute values.

These embodiments, as well as other embodiments of the present disclosure, demonstrate that using intelligent policy-based geo-fencing, a geo-fence may be validated depending on the logic of the policy as well as real-time values of any attributes that may be consumed by the policy. As the policy changes and/or the attribute values used to construct the policy change, the results of the geo-fence evaluation also may change resulting in different actions being invoked. It should be appreciated that embodiments of the present disclosure may provide for quick configuration and changes to the policy to easily provide different behavior as needed.

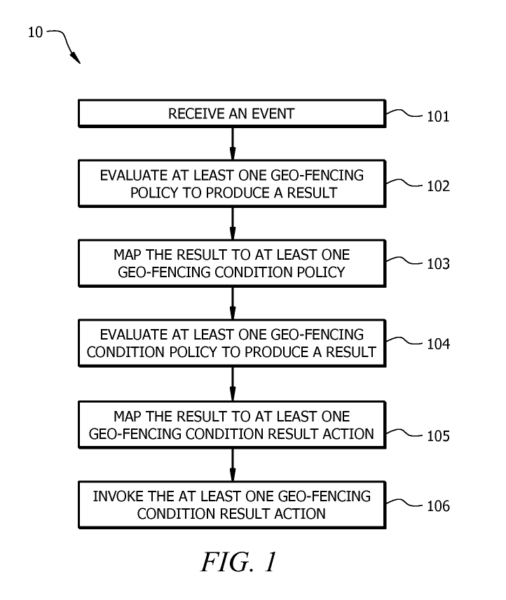

Intelligent policy-based geo-fencing generally may be comprised of several phases. Each of these phases may provide information and/or attributes to the context for the next phase to consume, either in policies or actions. FIG. 1 depicts a flow chart of a method of intelligent policy-based geo-fencing 10 according to an embodiment of the present disclosure.

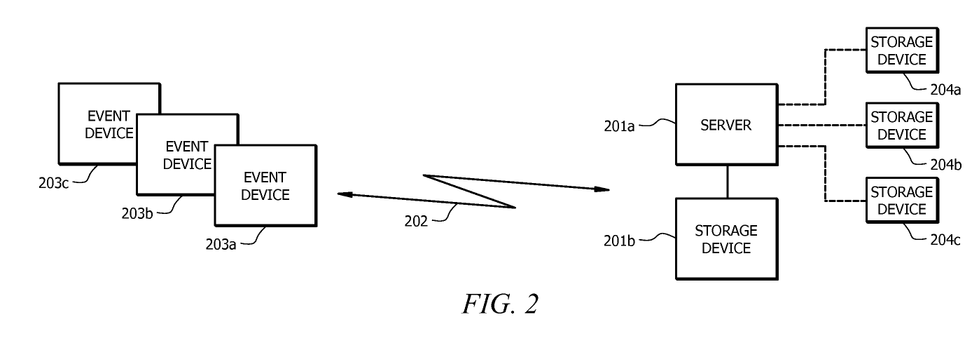

A geo-fencing system according to embodiments of the present disclosure is depicted in FIG. 2. Such a geo-fencing system may include at least one computer server 201a and at least one storage device 201b associated with one another for receiving signals from at least one event device 203a-c. Server 201a and storage device 201b also may transmit signals to at least one event device 203a-c in some embodiments of the present disclosure. Storage devices 204a-c also may be associated with server 201a but may be external to the system. It should be appreciated that storage devices may include, but are not necessarily limited to, databases, file repositories, and other file management systems. It also should be appreciated that these storage devices may be physically or virtually associated with server 201a and may be internal or external to the system. Server 201a may receive signals from at least one event device 203a-c through communication network 202, such as the Internet or a wireless network. Signals transmitted to and from the at least one station 201 over communication network 202 may include, but are not necessarily limited to, location data, time of day, weather conditions, speed, altitude, and other related data.

In step 101 of FIG. 1, an event may be received by a geo-fencing system. Upon receipt of the event, the intelligent policy-based geo-fencing evaluation process may be initiated.

It should be appreciated several different types of events may drive the policy-based geo-fencing evaluation process: asset-driven events, attribute-driven events, and anchor-driven events. Each of these events will be described in further detail below.

Intelligent policy-based geo-fencing evaluations may generally be invoked by an asset-driven event. An asset-driven event may be a trigger initiated by transmission of an asset's GPS coordinates causing geo-fencing policies to be evaluated. Information, such as predetermined attributes or details about the asset, also may be transmitted along with the asset's GPS coordinates. When an “asset,” is referenced, such as in an asset-driven event, it should be appreciated that an asset may be a mobile entity, with attributes, that may be associated to a device, or electronic hardware that may transmit GPS coordinates using a communication network, such as a cellular or wireless network.

Asset-driven events may occur when an asset's coordinates have been consumed and have been evaluated against qualified geo-fencing policies. The frequency of occurrence of an asset-driven event may be generally based on how often the asset's coordinates may be provided to a geo-fencing system. As an example, a geo-fence may be formed around the perimeter of a theme park and defined to inform security when a child wearing a GPS watch leaves the theme park geo-fence. In this instance, whenever a child's GPS watch transmits the child's location to a geo-fencing server, for example, this may be characterized as an asset-driven event.

An attribute-driven event may be a trigger initiated by the change of an attribute value causing geo-fencing policies to be evaluated. Evaluation of a geo-fencing policy may be invoked by the mere fact that an attribute value has changed. With an attribute-driven event, it is the changing of an attribute that invokes the geo-fence policy evaluation. Attribute-driven events may include, but are not necessarily limited to, changes in environmental attributes, such as time of day, weather, DEFCON, and/or Air Quality Index. When such a change in an environmental attribute occurs, a geo-fence may be triggered to evaluate and determine if any action should be taken.

An embodiment of an attribute-driven event triggering a geo-fence according to the present disclosure may occur in the context of security monitoring. For example, attributes associated with a geo-fence may entail having a security guard visit a particular area of the grounds that he/she patrols at certain times of the day, such as between 8 am and 10 am and between 2 pm and 4 pm. A time-of-day attribute-driven event may be triggered at 10 am and 4 pm in this embodiment of the present disclosure. When such a trigger occurs, the geo-fence may evaluate and use historical asset attributes to determine if the security guard has performed his/her responsibilities in accordance with the geo-fence policy. An alert or notification may be transmitted as a result of such evaluation.

In another embodiment of an attribute-driven event triggering a geo-fence according to the present disclosure, an attribute-driven event may be tied to a limit on the number of hours that an employee may work during a given week. As an example, a geo-fence may be set up at each construction job site that an excavation company manages. The excavation company may not want an employee working on certain job sites if that employee has already worked 40 hours during a given week. Accordingly, once the employee has worked 40 hours in a given week, the “hours worked” attribute for that employee would change. This attribute may then trigger an event to evaluate all qualified geo-fences that may be associated with that employee and notify the employee's supervisor if the employee has exceeded the policy at any of the job sites.

In a further embodiment of an attribute-driven event triggering a geo-fence according to the present disclosure, an attribute-driven event may be associated with certain weather conditions. For example, geo-fences may be constructed in a state park around danger zones known for having mudslides when rainstorms occur. When the risk of mudslides is high, a geo-fencing policy may notify park officials as to the number of visitors present in or around the danger zones. Additionally or alternatively, the policy may identify the geo-fences where the highest concentrations of children under the age of 16 years old may be presently located.

An anchor-driven event may be a trigger initiated by the transmission of an anchor's GPS coordinates that cause geo-fencing policies to be evaluated. An anchor-driven event may be considered a subset of an asset-driven event where the asset's coordinates are anchored to a geo-fence. This type of event occurs when a mobile geo-fence is associated with an entity. Similar to an asset-driven event, an anchor-driven event may be triggered when an anchor's coordinates have been consumed. Accordingly, evaluation of a geo-fence occurs as the change in the anchor's position impacts surrounding assets or policies.

An embodiment of a geo-fence evaluated based on an anchor-driven event according to the present disclosure may include notification when a parent and his/her child have been separated by more than a predefined distance. For example, a parent may be traveling with three children, each child wearing or carrying a GPS device. The parent may desire to be notified if any one of the three children is more than 30 feet (or some other predefined distance) away from him/her. In order to do so, the parent may set up a mobile geo-fence around the three children. Once the parent's location coordinates have been consumed, any policies associated with such a mobile geo-fence may be evaluated to determine if each of the three children are presently within the mobile geo-fence. If one or more of the three children are outside of the mobile geo-fence, the parent may be notified or alerted.

Another embodiment of a geo-fence evaluated based on an anchor-driven event according to the present disclosure may occur in the home-buying context. As an example, a prospective homebuyer may drive around in various neighborhoods searching for a home to purchase based on particular criteria. The particular criteria may include, but may not necessarily be limited to, square footage, price, number of bedrooms, and/or a pool. The particular criteria may be referred to as landmark attribute information, and this information may be captured in a geo-fence that may be anchored to the prospective homebuyer. When the prospective homebuyer's coordinates have been consumed, his/her geo-fencing policy may be evaluated. If the landmark attribute information associated with the geo-fence is present in a given location, the prospective homebuyer may be notified of each home matching his/her landmark attribute information.

For both asset and anchor-driven events, the coordinates of the entities may be used to determine if the coordinates are inside or outside of the geo-fence (i.e., whether the coordinates are in/out). If no determination can be made, a result of “indeterminate” may be returned.

In step 102 of FIG. 1, at least one geo-fencing policy may be evaluated to produce a result. This result may then be mapped to at least one geo-fencing condition policy. In evaluating an intelligent policy-based geo-fence, when an event is received by a geo-fencing system, all qualified geo-fences generally may be evaluated. The result of such evaluation may be in/out/indeterminate. This result may be mapped to at least one geo-fencing condition policy in step 103. A geo-fencing condition policy may be comprised of attributes and logic to provide rules and intelligence to the geo-fence. Conditions also may be a set of expressions comprised of attributes and/or functions to structure the designed behavior of the policy.

The at least one geo-fencing condition policy may then be evaluated to produce a result in step 104. In this step, server 201a in conjunction with at least one storage device may receive values from event device 203a-c and place them in the condition policy context for evaluation. Once the desired attributes have been provided and any functions have been applied, the attributes and/or logic comprising the condition policy may be executed by the server, such as server 201a, to render a true, false, or indeterminate result.

In step 105, the result (true, false, or indeterminate) may then be mapped to at least one geo-fencing condition result action. It should be appreciated that there may be more than one geo-fencing condition result action associated with each geo-fencing condition policy evaluation result, including true, false, or indeterminate. For example, if the geo-fencing condition policy evaluation result is true, one type of condition result action may be invoked. Alternatively, if the geo-fencing condition policy evaluation result is false or indeterminate, a different type of condition result action may be invoked. The same condition result action may even be invoked because the policy was evaluated by mapping that action to all potential results.

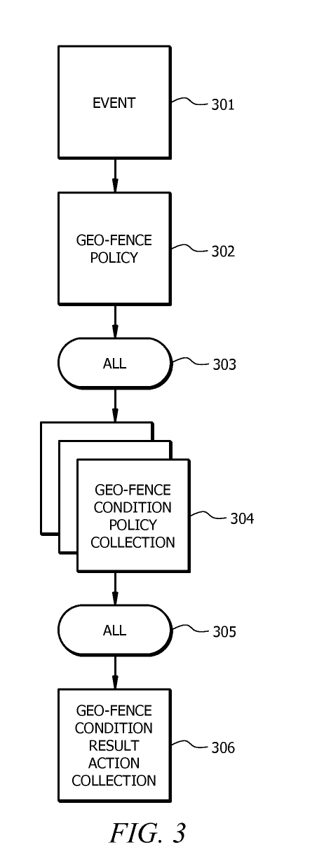

It should further be appreciated that the geo-fencing condition policy processing may be set up to invoke a collection of geo-fencing condition result actions regardless of the geo-fencing condition policy evaluation result. This may be referred to as an “all” type scenario as depicted in FIG. 3.

When the condition policies are mapped to the respective geo-fencing policy results, an override may be provided in the geo-fencing system that may instruct the geo-fencing system to stop processing the collection of condition policies after the first policy in the collection has been evaluated to true or false, or a combination thereof. The override also may instruct the geo-fencing system to stop processing after the first policy has been evaluated and has returned any result that is not indeterminate.

Once the condition policies have been mapped to the geo-fencing policy evaluation result(s), the policy context may be further enriched using attribute values defined in the conditions in real-time. These attributes may include, but are not limited to, device attributes, asset attributes, landmark attributes, environment attributes, and geo-fence attributes.

In step 106 of FIG. 1, at least one geo-fencing condition result action may be invoked. It should be appreciated that a condition result action may occur on any type of result from an actual condition policy. For example, if the result of the condition policy evaluation is “true,” a condition result action may be to send an email. In another embodiment of the present disclosure, if the result of the condition policy evaluation is true or false, the condition result action may be to send a text message. However, it should be appreciated that any condition result action can be configured to occur as a result of any particular condition policy.

Result actions may include, but are not necessarily limited to, alerting or notifying an individual, system or application, updating data in a repository that may include asset attributes, and/or modifying the geo-fence itself and/or its policies. In an embodiment of the present disclosure, based on a condition policy result, an alert, message, or notification in the form of an email, text, phone call or other type of communication may be invoked to notify an individual or system. However, it should be appreciated that result actions are not limited to the above-mentioned actions.

Another embodiment of the present disclosure may entail modification of attributes in response to a specified condition policy result. For example, a condition policy may effectuate a result action of updating attributes in a storage device. It should be appreciated that other forms of logging or updating may be performed as result actions, according to embodiments of the present disclosure. For example, attributes may be updated in more than one storage device, and/or more than one field in a storage device may be updated or modified in response to a condition policy.

In another embodiment of the present disclosure, based on the result of a geo-fencing condition policy evaluation, a geo-fencing condition result action may be to modify other existing geo-fence condition policies. In a further embodiment of the present disclosure, a condition result action may be to modify an existing geo-fence perimeter or territory. It also should be appreciated that another event may occur depending on the result of a geo-fencing condition policy evaluation. For example, a condition result action may be to send another event to the geo-fencing system to be further evaluated according to embodiments of the present disclosure. Again it should be appreciated that there may be multiple geo-fencing condition result actions associated with the same geo-fencing condition policy result.

FIG. 3 depicts an embodiment of the present disclosure where the same geo-fencing condition policy may be applied to all potential geo-fencing policy results and all geo-fencing condition result actions may be applied to all potential results of the condition policy (also referred to as the “all” type scenario). In FIG. 3, event 301 invokes geo-fence policy 302, and the output of geo-fence policy 302 is “all” (303). Because the output of geo-fence policy 302 is “all,” the entire geo-fence condition policy collection 304 may be accessed, and the output of geo-fence condition policy collection 304 is “all” (305). Accordingly, the entire collection of geo-fence condition result actions 306 may be invoked regardless whether the result of geo-fencing policy evaluation is in, out, or indeterminate or the result of the geo-fencing condition policy evaluation is true, false, or indeterminate.

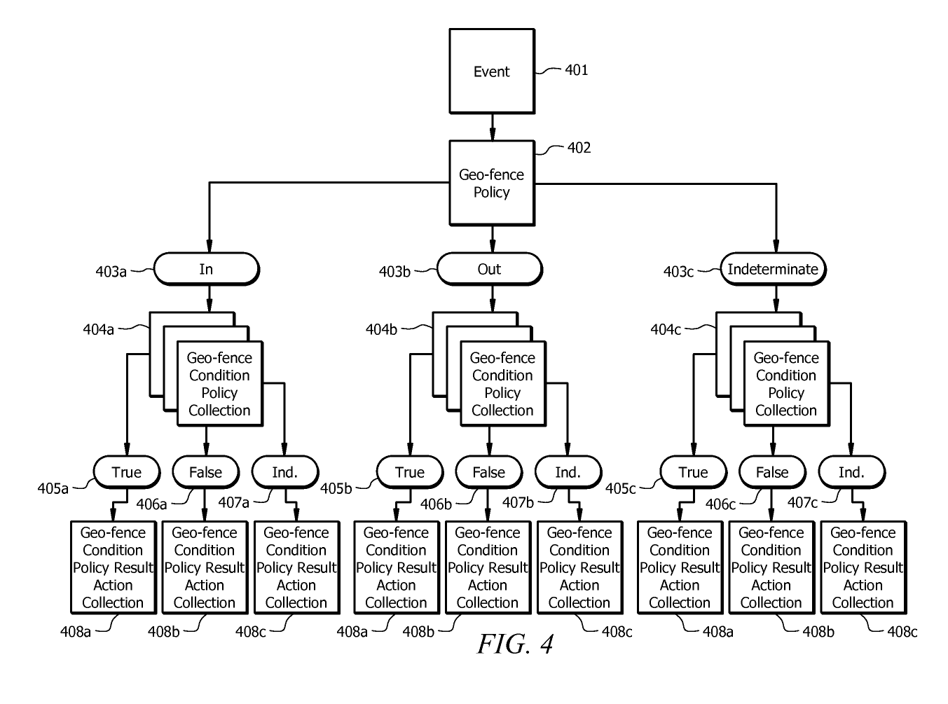

Intelligent policy-based geo-fencing also may occur according to an embodiment of the present disclosure. Such an embodiment is depicted in FIG. 4. Event 401 may be received and used to evaluate geo-fencing policy 402, and a result of such evaluation may be “in” (403a), “out” (403b) and/or “indeterminate” (403c). The result of such evaluation may be mapped to a collection of geo-fence condition policies 404a-c. The evaluation of condition policy collection 404a-c will provide a result of “true” (405a, 406a, 407a), “false” (405b, 406b, 407b), and/or “indeterminate” (405c, 406c, 407c). Depending on the result of the geo-fence condition policy evaluation, at least one geo-fence condition result action in the associated collection (408a-c, 409a-c and/or 410a-c) may be invoked.

Several of the embodiments of the present disclosure have been described with respect to fixed area geo-fences. However, it should be appreciated that intelligent policy-based geo-fencing may also be used for mobile geo-fences. Regardless of the type of geo-fence that may be employed, a geo-fencing condition policy may still be applied. Further, it should be appreciated that such a geo-fencing condition policy may be expressed, stored, and processed using mark-up languages, such as XML, or written languages, such as SQL, as well as other existing or custom languages.

Assets also may be dynamically connected to one another utilizing intelligent policy-based geo-fencing according to embodiments of the present disclosure. This may be referred to as “geo-tethering;” however, other terms or phrases may be used to refer to dynamic connection of assets without departing from the present disclosure. With geo-tethering, policies may be implemented that may further limit how far one asset may stray from another asset.

In an embodiment of the present disclosure, each student (asset) within a group of students (assets) wears a GPS device on a field trip. The students may be permitted to separate from the group during the field trip on the condition that each student remains with no fewer than three other students at any given time. The geo-fence may be configured such that the group of no less than four students must remain within a configurable distance from one another in order to be classified as a group. If the group becomes less than four students at any given time, the field trip leader may be notified or alerted.

In a further embodiment of geo-tethering according to the present disclosure, as in the prior embodiment described above, the students on a field trip may separate from the group during the field trip on the condition that each student remains with no fewer than three other students at any given time. However, in this embodiment, each group of at least 4 students must include at least one male student. Accordingly, the geo-fence may be provisioned to alert or notify the field trip leader if any group has less than 4 students and/or does not include at least one male student.

With geo-tethering according to embodiments of the present disclosure, it should be appreciated that assets may define their own groups on the condition that they abide by the rules provisioned in the geo-fence. These conditions permit the assets to be dynamically tethered together.

In other embodiments of the present disclosure, the assets comprising any given group may be individually identified in a geo-fencing system. Accordingly, no single asset may be permitted to stray from his/her designated group. Returning to the field trip example, the students on a field trip may be divided up into smaller groups, and each student may be assigned to a specific group. The geo-fence policy may be provisioned to state that a specific group is considered to be intact as long as all students assigned to the specific group remain within a configurable distance of one another. If any student within the group is no longer within the configurable distance of the other students within his/her group, the field trip leader may be alerted or notified. In this embodiment of the present disclosure, assets may be linked and more specifications may be included in the geo-fencing policy to further track assets through geo-tethering.

In a further embodiment of the present disclosure, even more dynamic policies may be provided by incorporation of time-of-day parameters. For example, a student may be required to remain within a configurable distance of the other students in his/her assigned group after 5 pm or after the time when the sun sets.

Although the present disclosure has been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure, processes, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

1. A method of policy-based geo-fencing using a server-based geo-fencing system, said method comprising:
receiving an event;
evaluating at least one geo-fencing policy to produce a first result;
mapping said first result to at least one geo-fencing condition policy;
evaluating said at least one geo-fencing condition policy to produce a second result;
mapping said second result to at least one geo-fencing condition result action; and
invoking said at least one geo-fencing condition result action.

2. The method of claim 1, wherein a geo-fence associated with said server-based geo-fencing system is fixed.

3. The method of claim 1, wherein a geo-fence associated with said server-based geo-fencing system is mobile.

4. The method of claim 1, wherein said at least one geo-fencing condition result action is selected from the group comprising:
sending an alert, message or notification, modifying a geo-fence, modifying a geo-fencing policy, sending another event to said geo-fencing system, and updating or modifying attributes in at least one storage device.

5. The method of claim 1, said event selected from the group comprising:
an asset-driven event, an attribute-driven event, and an anchor-driven event.

6. The method of claim 1, wherein upon receipt of said event, all qualified geo-fences are evaluated.

7. The method of claim 1, wherein said first result is “in,” “out,” or “indeterminate.”

8. The method of claim 5, wherein said attribute-driven event includes a change in at least one attribute selected from the group comprising:
time of day, hours worked, weather, DEFCON, and Air Quality Index.

9. The method of claim 1, wherein said second result is “true,” “false,” or “indeterminate.”

10. The method of claim 1, said method further comprising:
fetching real-time attribute values to be used in said evaluating said at least one geo-fencing condition policy to produce a second result, said real-time attribute values selected from the group comprising:
device attributes, asset attributes, landmark attributes, environment attributes, and geo-fence attributes.

11. The method of claim 1, said server-based geo-fencing system comprising:
at least one server and at least one storage device; and
at least one communication network,
wherein said at least one server receives signals from at least one event device through said at least one communication network.

12. The method of claim 11, wherein said at least one server transmits signals to at least one event device through said at least one communication network.

13. A method of geo-fencing using a server-based geo-fencing system, said method comprising:
invoking at least one geo-fencing condition result action by evaluating at least one geo-fencing policy and at least one geo-fencing condition policy.

14. The method of claim 13, said method further comprising:
mapping the result of evaluating said at least one geo-fencing policy to said at least one geo-fencing condition policy.

15. The method of claim 13, said method further comprising:
mapping the result of evaluating said at least one geo-fencing condition policy to said at least one geo-fencing condition result action.

16. The method of claim 13, wherein said at least one geo-fencing condition result action is selected from the group comprising:
sending an alert, message or notification, modifying a geo-fence, modifying a geo-fencing policy, sending an event, and updating or modifying attributes in at least one storage device.

17. The method of claim 13, said server-based geo-fencing system comprising:
at least one server and at least one storage device; and
at least one communication network,
wherein said at least one server receives signals from at least one event device through said at least one communication network.

18. A method for dynamically connecting assets to one another with a server-based geo-fencing system, said method comprising:
configuring a geo-fencing policy to require each asset within a group to remain within a predefined distance of the other assets within said group;
evaluating said geo-fencing policy and mapping said geo-fencing policy to at least one geo-fencing condition policy;
evaluating said geo-fencing condition policy and mapping said geo-fencing condition policy to at least one geo-fencing condition result action; and
invoking said at least one geo-fencing condition result action.

19. The method of claim 18, wherein each asset within said group is individually identified and evaluated by said server-based geo-fencing system.

20. The method of claim 18, wherein said assets define said group based on the condition that said assets abide by said geo-fencing condition policy.
